(19) United States
(12) Patent Application Publication
(10) Pub. No.: US 2011/0240077 A1
(43) Pub. Date: Oct. 6, 2011

(54) ASSISTIVE MOBILITY DEVICE

(76) Inventors: Sarah Doherty, Roberts Creek (CA); Kerith Perreurlloyd, Roberts Creek (CA); William Johnson, Markham (CA); Gary Moonie, Sidney (CA); Christopher John Foreman, Victoria (CA)

(21) Appl. No.: 13/139,699

(22) PCT Filed: Dec. 15, 2009
(86) PCT No.: PCT/CA09/01854

§ 371 Date: Jun. 14, 2011

Related U.S. Application Data
(60) Provisional application No. 61/122,486, filed on Dec. 15, 2008.
(60) Provisional application No. 61/237,278, filed on Aug. 26, 2009.

(51) Int. Cl. A61H 3/02; A45B 9/02; A45B 9/04

(52) U.S. Cl. 135/71; 135/75; 135/72; 135/77; 135/84

(57) ABSTRACT

The present invention is directed to an assistive mobility device, for example a walking stick or a crutch, for ergonomically assisting its user to traverse both urban and more challenging terrain. The device includes an elongated pole to support the user and a hand grip by which the user grips the proximate end of the pole. The hand grip is connected to the pole through a user-adjustable damper for absorbing shock. A variety of interchangeable tips are available for the distal end of the pole to adapt the device for a variety of terrains and uses.

### FIELD

The present invention is directed to the general field of human mobility assistance.

### BACKGROUND

Crutch walking, for the purposes of this disclosure, can be defined as the use of mobility supports necessitated by a temporary or permanent functional injury to, or the partial or complete loss of a lower limb.

The nature of crutch walking is such that an exceptional burden is placed on the upper extremities. The highly repetitive and weight bearing nature of crutch walking is often associated with the development of upper limb pain and dysfunction. Common linear forearm crutches force the user into an unnatural posture, straining the shoulder joint, upper limb muscles and tendons, merely in order to maintain perpendicularity with the ground. A more ergonomic configuration of forearm assembly, able to support the user while resisting strain, pain, fatigue or additional dysfunction, is highly desirable.

Crutch walking also entails repeated impact of the crutch with the ground, and various means of lessening this impact have been employed in the past. An 1841 U.S. Pat. No. 2,297, titled Ferrule for Cane, employs a “steel spiral spring within the ferrule . . . ” [which] “ . . . prevents the usual jar to the hand or shoulder . . . ” Crutches employing some form of coil spring suspension to absorb shock thus exist in the art, but are not an optimal solution because a spring responds to increased weight by bouncing back instead of absorbing the impact in a controlled and consistent manner. For this reason, spring-like crutch suspension systems, on their own, are ill-suited to “absorbing” impacts with the ground while retaining optimal control during mobility. Damping mechanisms quickly and consistently reduce the amplitude of oscillations in a suspension system. Therefore, improvements in crutch system design should include a means to dampen repeated impacts with the ground, only springing back when the weight of the user is released.

While some prior art solutions employ hydraulic, pneumatic or elastomeric dampers, all have positioned the damping mechanism at the distal end of the crutch, cane, pole, etc, and are fitted onto the end of commonly available, mass-produced, low quality crutch poles. By positioning the damping mechanism at the end, instead of the middle of the crutch, less leverage, and therefore less damping is possible. A centrally positioned damping assembly moves the centre of mass closer to the centre of force (forearm and shoulder), thereby reducing effort for the user. No prior art damping crutch systems are designed to be integrated with an ergonomic forearm assembly, nor with interchangeable tips which provide optimal multi-terrain traction only when employed in partnership with a centrally positioned damping system. Therefore, new crutch designs should include a damping mechanism located in the center of a crutch for more efficient damping and optimal traction control.

Crutch walking entails repeated impact with terrains of variable friction, density, viscosity and angle. Active crutch walkers do not want to limit their lifestyle to urban environments, and may be found perambulating along hiking trails, logging roads, mountainsides, glaciers, creek beds, snowfields, sand, and other terrains that are often problematic for the fully-abled person. Therefore any improvements to crutch system design should ensure that those elements actually contacting the ground (crutch tips) are capable of maintaining optimal control and stability for each terrain encountered by the user. Also, crutch tips should be easily interchangeable, thereby providing appropriate traction, cushion and mobility in all circumstances.

The hand grip of a crutch provides the only support for the body weight in swing gait walking and significant weight support in 4-point and other gate patterns. The use of the hand grip places abnormal amounts of pressure on the forearms, wrists and hands, especially with persons requiring long-term use of crutches or walking sticks. In order to reduce the impact to the upper body of a user, support and stability needs to come from the design of an ergonomic handle. This handle needs to provide a variety of “ergonomic” options for crutch users to reduce injuries common to long-term use such as but not limited to: carpal tunnel syndrome, tendinitis and neuropathy.

Currently, no known hand grip exists specifically for the crutch or walking stick which has been designed to ergonomically aid users of crutches or walking sticks and their distinct load bearing needs. U.S. Patent Publication Number 2008/0013702 outlines a grip which has been designed for the loads exerted onto the hand grips of bicycles. The loads exerted by a bicyclist puts onto a grip of a bicycle and a user of an assistive mobility device such as a crutch or walking stick puts onto a grip of an assistive mobility device are distinct.

### SUMMARY

The multi-terrain damping ergonomic forearm crutch system and walking stick system are designed to reduce the physical impact and increase the safety for crutch users traveling along a variety of urban and extreme terrains including, but not limited to urban streets, cambered or uneven roadways, hiking trails, rock slopes, ice fields, sandy deserts or beaches, snowfields, glaciers, mountains, etc.

The disclosed crutch system provides a more ergonomic configuration of forearm assembly which is able to support the user while resisting strain, pain, fatigue or additional dysfunction. It provides a mechanism which reliably dampens repeated impacts with the ground, only springing back when the weight of the user is released. This damping mechanism is located close to the forearm assembly in order to reduce the inertia and corresponding fatigue from weight placed at the bottom of a crutch or walking stick. The disclosed crutch system provides an integrated series of interchangeable and adjustable crutch tips capable of maintaining optimal control and stability for each terrain encountered by the user.

The prior art does not appear to reveal any modular crutch walking systems that employ all of the above features, including the means to swap cuffs, handles or tips, or to utilize commonly available materials or components from the biking or aerospace industry in order to allow use of local resources and maintenance options.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have is been solely selected for ease of recognition in the drawings.

FIG. 1a is a side view of an embodiment of an assistive mobility device according to aspects of the present invention, more specifically an embodiment of a forearm crutch system.

FIG. 1b is a sectional side detail view of an embodiment of a forearm assembly with common attachments according to aspects of the present invention, compatible with the crutch system of FIG. 1a.

FIG. 2a is a sectional side view of an embodiment of a hydraulic damper assembly according to aspects of the present invention, compatible with the crutch system of FIG. 1a.

FIG. 2b is an exploded sectional side view of the damper of FIG. 2a.

FIG. 3a is a sectional side view of an embodiment of an elastomeric damper assembly according to aspects of the present invention, compatible with the crutch system of FIG. 1a.

FIG. 3b is a sectional side view of an embodiment of an internal spring hydraulic damper assembly according to aspects of the present invention, compatible with the crutch system of FIG. 1a.

FIG. 4a is a sectional side view of an embodiment of a general use (walking) tip according to aspects of the present invention, compatible with the crutch system of FIG. 1a.

FIG. 4b is a bottom view of the general use (walking) tip of FIG. 4a.

FIG. 5a is a sectional side view of an embodiment of a hiking tip according to aspects of the present invention, compatible with the crutch system of FIG. 1a.

FIG. 5b is a bottom view of the hiking tip of FIG. 5a.

FIG. 6a is a sectional side view of an embodiment of an ice tip according to aspects of the present invention, compatible with the crutch system of FIG. 1a.

FIG. 6b is a bottom view of the ice tip of FIG. 6a.

FIG. 7a is a sectional side view of an embodiment of an articulating multi-terrain tip (AMT) with a protruding studded foot according to aspects of the present invention, compatible with the crutch system of FIG. 1a.

FIG. 7b is a bottom view of the ice tip of FIG. 7a.

FIG. 8a is a sectional side detail view of the AMT of FIG. 7a with an embodiment of a general use (walking) foot according to aspects of the present invention, compatible with the crutch system of FIG. 1a.

FIG. 8b is a bottom view of the embodiment of FIG. 8a.

FIG. 8c is a sectional side detail view of the AMT of FIG. 7a with an embodiment of an exposed studded foot according to aspects of the present invention, compatible with the crutch system of FIG. 1a.

FIG. 8d is a bottom view of the embodiment of FIG. 8c.

FIG. 8e is a sectional side detail view of the AMT of FIG. 7a with an embodiment of a recessed studded foot according to aspects of the present invention, compatible with the crutch system of FIG. 1a.

FIG. 8f is a bottom view of the embodiment of FIG. 8e.

FIG. 8g is a sectional side detail view of the AMT of FIG. 7a with an embodiment of a recessed studded foot using a metal plate according to aspects of the present invention, compatible with the crutch system of FIG. 1a.

FIG. 8h is a bottom view of the embodiment of FIG. 8g.

FIG. 9a is a top view of an embodiment of a snow tip according to aspects of the present invention, compatible with the crutch system of FIG. 1a.

FIG. 9b is a sectional side view of the snow tip of FIG. 9a.

FIG. 9c is a side view of the snow tip of FIG. 9a.

FIG. 9d is a top view of an embodiment of an alternative embodiment of a snow tip according to aspects of the present invention, compatible with the crutch system of FIG. 1a.

FIG. 9e is a sectional side view of the snow tip of FIG. 9d.

FIG. 9f is a side view of the snow tip of FIG. 9d.

FIG. 10a is a photographic view detailing an embodiment according to aspects of the present invention of a socket portion of a connection between a damping assembly such as depicted in FIGS. 1-3 and the distal end of a forearm assembly such as depicted in FIG. 1.

FIG. 10b is a photographic view detailing an embodiment according to aspects of the present invention of a shaft portion of the connection of FIG. 10a.

FIG. 11a is a sectional side view of the forearm assembly, damping assembly and connection of FIG. 10.

FIG. 11b is an exploded sectional side view of the forearm assembly, damping assembly and connection of FIG. 10.

FIG. 12 is a sectional side view detailing an embodiment according to aspects of the present invention of a connection between the distal end of a crutch pole such as depicted in FIG. 1 and a tip such as depicted in FIGS. 1 and 4-9.

FIG. 13 is an exploded sectional side view of the crutch pole, tip and connection of FIG. 12.

FIG. 14 is a side view of another embodiment of an assistive mobility device according to aspects of the present invention, more specifically an embodiment of a walking stick assembly.

FIG. 15a is a top view of an embodiment of a hand grip according to aspects of the present invention, compatible with the walking stick assembly of FIG. 14.

FIG. 15b is a side view of the hand grip of FIG. 15a.

FIG. 15c is a bottom view of the hand grip of FIG. 15a.

FIG. 15d is a cross-sectional view of the hand grip of FIG. 15a.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Unless the context requires otherwise, throughout the specification and claims which follow, the word “comprise” and variations thereof, such as, “comprises” and “comprising” are to be construed in an open, inclusive sense, which is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

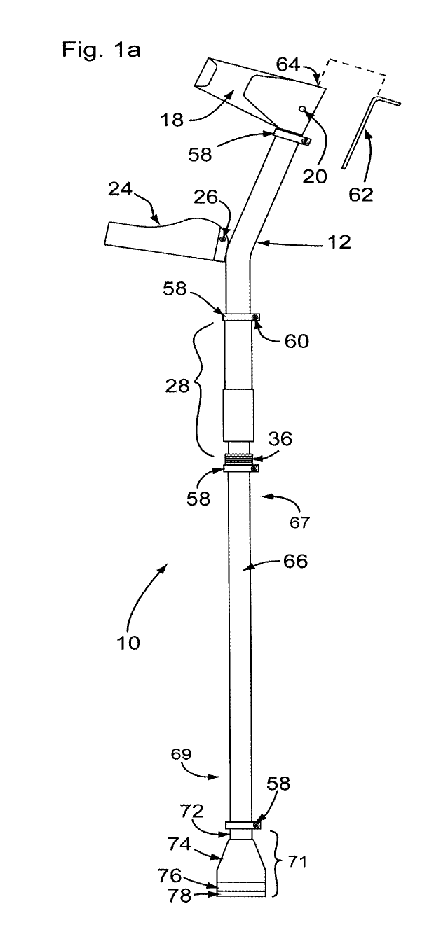

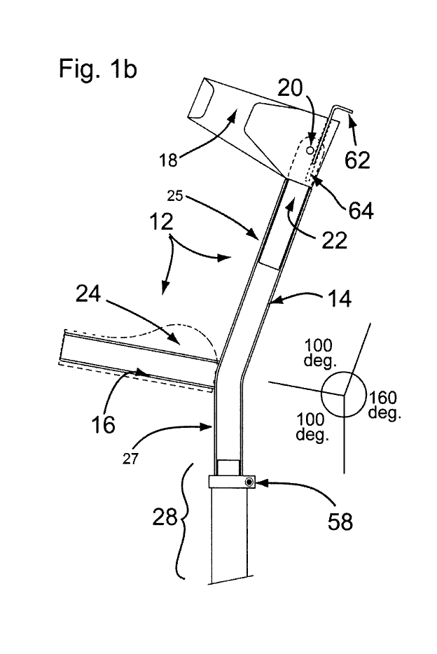

FIG. 1a shows an assistive mobility device according to certain aspects of the invention, namely one embodiment of a representative ergonomic forearm crutch system 10. The crutch system 10 may include an elongated crutch pole 66 having an upper end 67 and a lower end 69. The crutch pole 66 may be tubular. An ergonomic hand grip 24 may be connected to the upper end 67 of the crutch pole by way of a damping assembly 28. A removable tip 71 may be connected to the lower end 69 of the crutch pole 66.

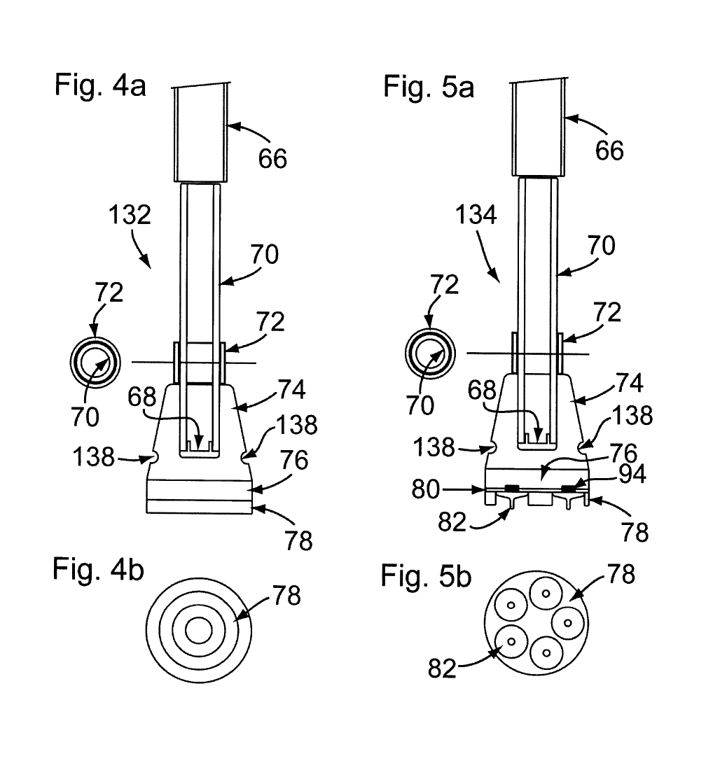

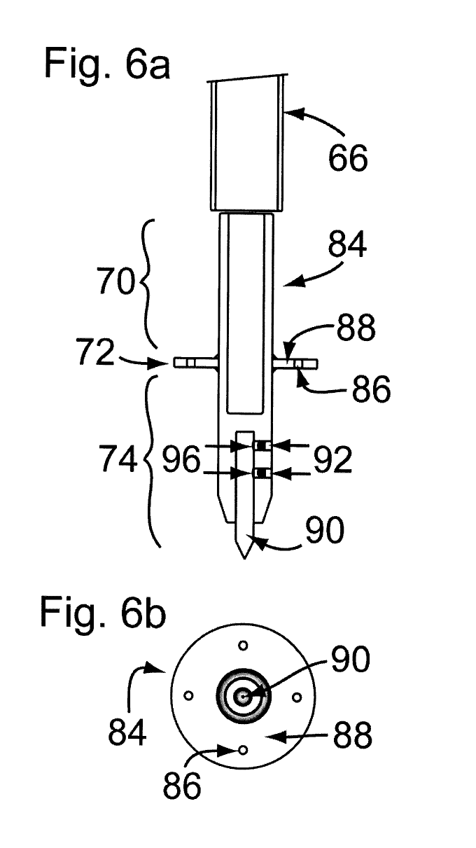

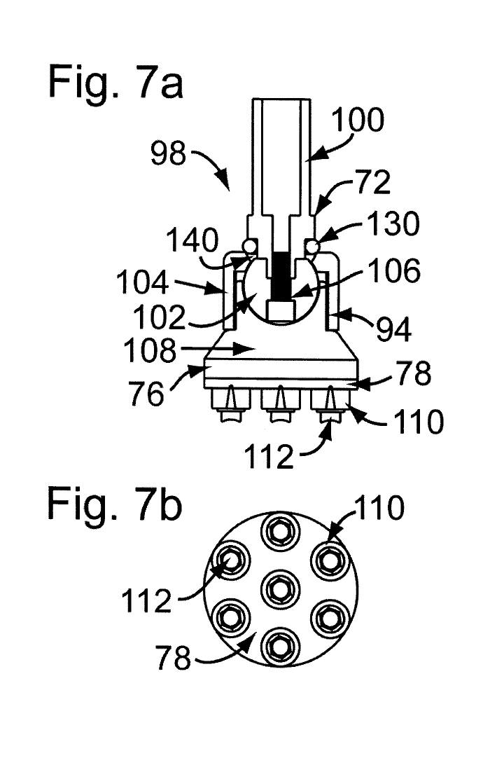

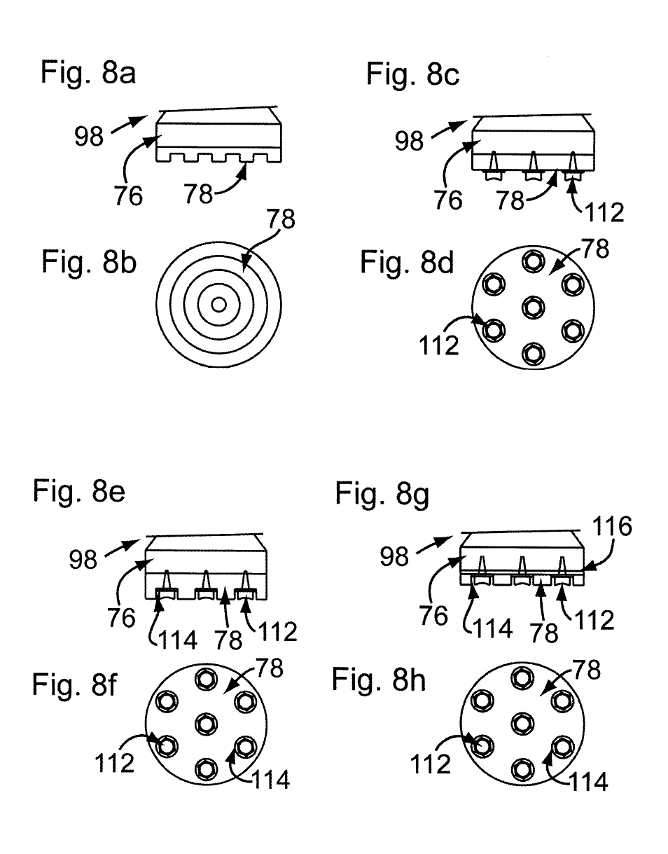

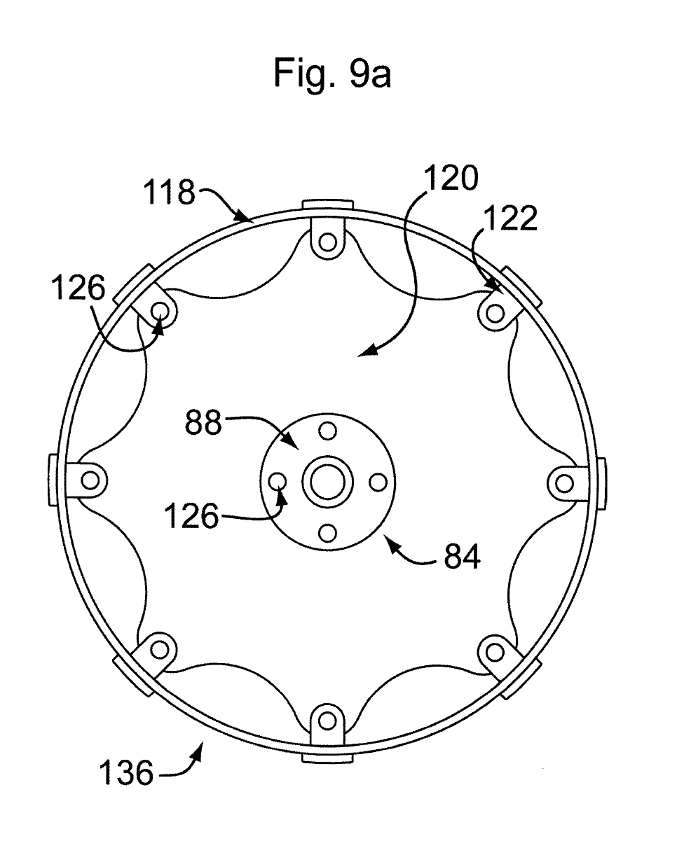

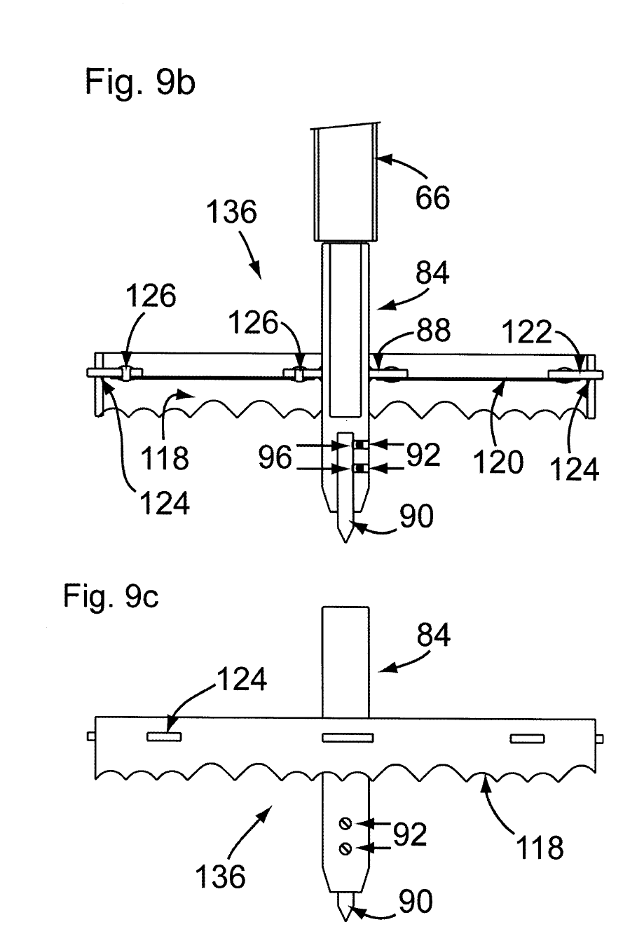

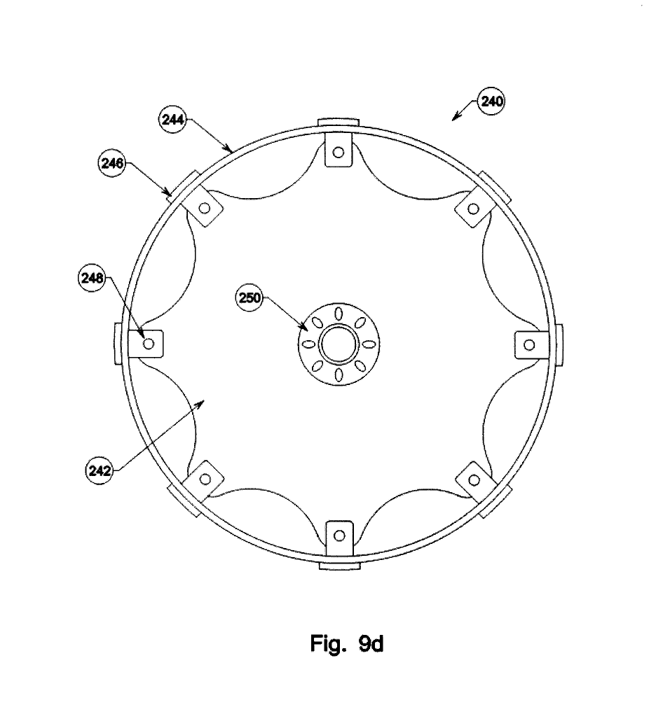

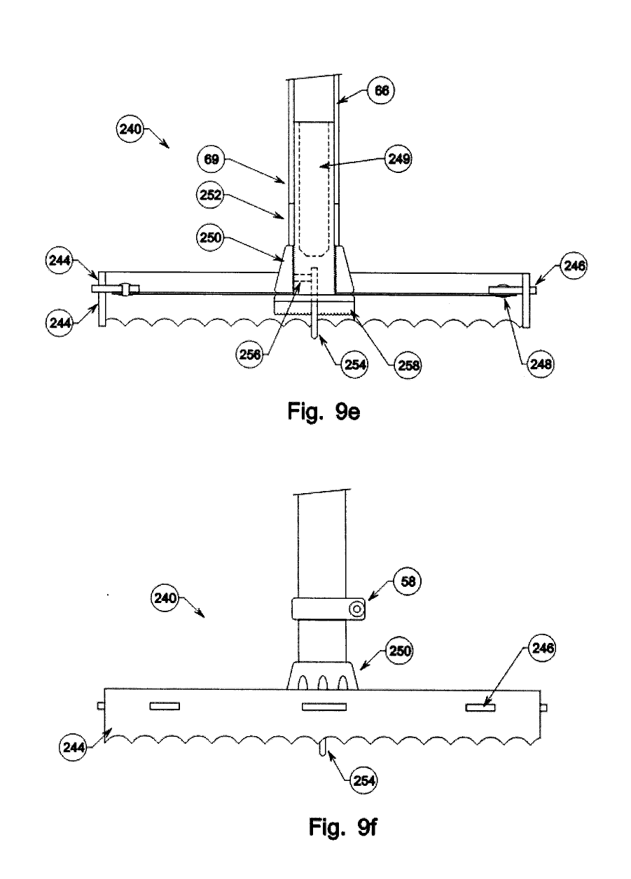

FIG. 1a shows a representative embodiment of a general use tip 71 with a tip body 74, tube stop 72, a cushion 76, and a sole 78 material which may be the foundation for a variety of traction solutions as described in more detail below. Some embodiments of the general use tip 71 may include the general use tip 132 of FIG. 4, the hiking tip 134 of FIG. 5, the ice pin 90 of FIG. 6, the articulating multi-terrain tip 98 of FIGS. 7 and 8, the snow tip 136 of FIGS. 9a to 9c, and the snow tip 240 of FIGS. 9d to 9f.

The hand grip 24 may incorporate into an ergonomic forearm assembly 12, which may include a cuff 18 with pivot bolt 20. The ergonomic forearm assembly 12 may be connected to the damping assembly 28, including its coupling o-rings 36.

All tubular elements are connected by means of bolted 60 c-clamps 58, except the hand grip with c-clamp and respective grip bolt 26. In some embodiments, clamp bolts 60 may be tightened with a tool such as a bolt key 62, in this case an appropriately sized Allen key, which may be housed in a key slot 64 in the cuff 18 for easy access and retention.

FIG. 1b shows an embodiment of the ergonomic forearm assembly 12 with attachments. The ergonomic forearm assembly 12 may be comprised of a handle tube 16 welded to a bent forearm tube 14, as illustrated substantially normal to the outside bend. The bent forearm tube may form an angle between a proximal end of the forearm tube 25 and a distal end of the forearm tube 27. One desirable angular configuration of the forearm assembly 12 may be defined by the reference mark beside the drawing. The cuff 18 may slide into the top of the forearm tube 14 by means of its pivot arm 22, which may be attached by a pivot bolt 20. The bolt key 62 is shown partly inserted into the key slot 64 into the pivoting body of the cuff 18. In some embodiments, an ergonomically shaped hand grip 24, as shown, may slide onto the forearm assembly, and the top portion of the damping assembly 28 may, as shown, be attached to the bottom of the forearm tube by means of a c-clamp 58.

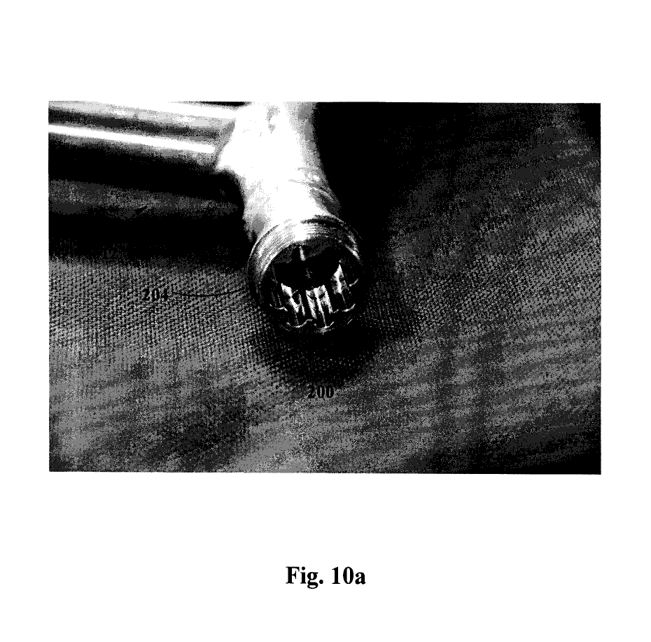

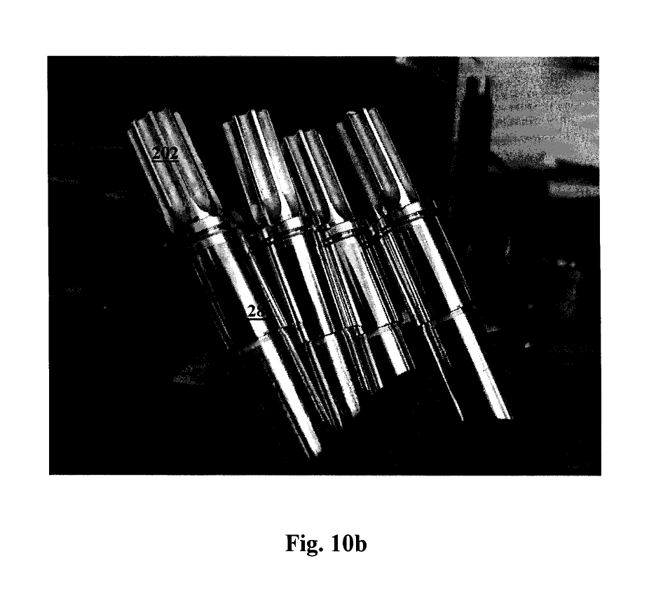

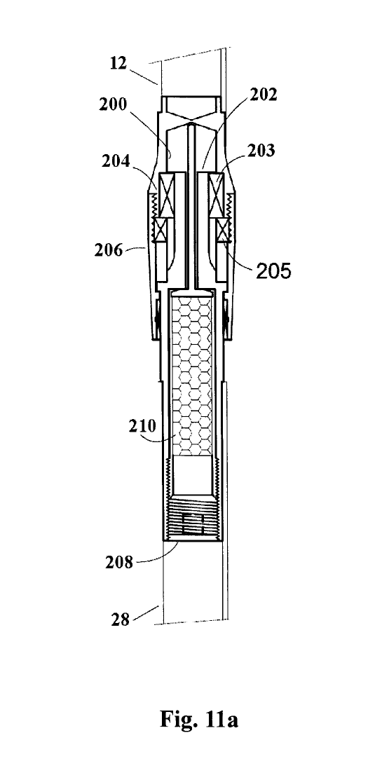

Note: for easier understanding of the following description, refer to both FIGS. 10a and 10b together. FIG. 10a and FIG. 10b detail an embodiment of the connection between the damping assembly 28 and the distal end of the forearm assembly 27. The distal end of the forearm assembly 27 may be characterized by a grooved socket 200 adapted to mate with a corresponding splined shaft 202 on the damping assembly 28. The distal end of the forearm assembly 27 may be further characterized by an externally threaded flange 204.

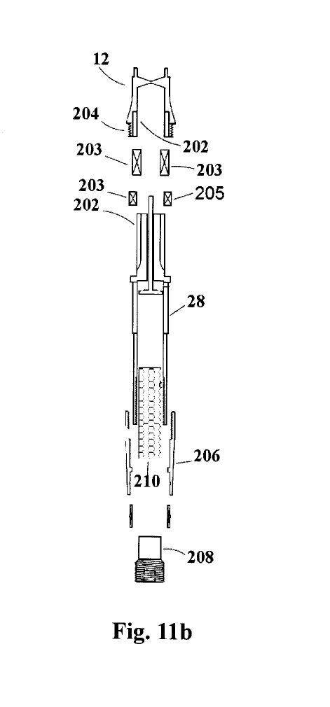

FIG. 11a and FIG. 11b further detail an embodiment of the connection between the damping assembly 28 and the distal end of the forearm assembly 27. A plurality of pins 203 may be interspersed between the grooved socket 200 grooves and the splines of the splined shaft 202 for improved connection. There further exists a retaining collar 205. The pins 203 may be made, for example, of polyoxymethylene, known commonly by the trade-mark Delrin® of E. I. du Pont de Nemours and Company. The pins 203 and the retaining collar 205 may be formed in one piece. A locking collar 206 connected to the damping assembly 28 may include internal threads adapted to mate with the externally threaded flange 204 and made to draw the forearm assembly 12 and the damping assembly 28 together.

The damping assembly 28 may further include a pre-tensioner 208 adapted to enable a user to adjust the characteristics of the damping medium 210, for example a spring or captive elastomer, oil, gas or air. In this embodiment, the pre-tensioner 208 may be threaded plug that may be screwed into and out of the damping assembly 28 to pre-tension the damping medium 210. The damping medium may be the hydraulic damper 48, the elastomeric damper 50, the internal spring hydraulic damper 52, or a similar damping medium known to persons of skill in the art.

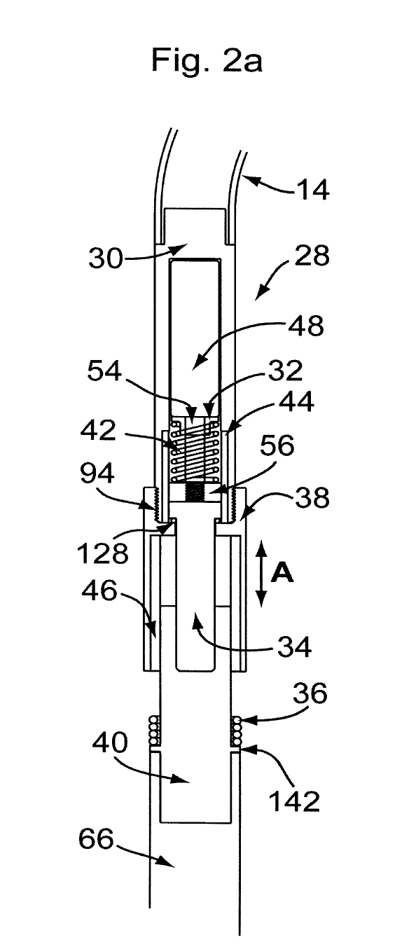

Note: for easier understanding of the following description, refer to both FIGS. 2a and 2b together. FIG. 2a shows an embodiment of the damping assembly 28 employing a hydraulic damper 48 and showing such external elements as the top housing 30 connected to the slide housing 38 by threading 94, then fitted into the coupling 40, which is cushioned from the crutch pole 66 by coupling o-rings 36. The coupling 40 may be prevented from sliding too far down the crutch pole 66 by means of a slide flange 142. The bottom of the forearm tube 14 may be clamped to the top of the top housing 30, and top of the crutch pole 66 may be clamped to that portion of the coupling 40 below the slide flange 142, both by means of c-clamps 58 not shown in this drawing. Internal elements may include a slide shaft 34 friction fitted into top of coupling 40, fitting through the slide housing 38 from the top, and contacting the bottom surface of the piston plate 56. The coupling 40 may slide inside a Teflon® guide 46 along the direction A as weight is placed on or removed from the above forearm tube 14. The top portion of the slide shaft 34 may fit into a hexagonal plastic guide 44 which may keys into the hexagonal bottom section of the top housing 30, in order to prevent the top housing 30 from rotating around the coupling 40, and thereby allowing the forearm assembly 12 to yaw around the crutch pole 66. A hydraulic dampener 48 may thread into the piston plate 56 by means of its piston rod 54 and fits inside the top housing 30, as shown. A spring 42 may be held in place by a spring retainer 32, with both sliding onto the piston rod 54 between the body of the hydraulic damper 48 and the piston plate 56. The coupling o-rings 36 may act as a backstop or cushion to prevent the bottom of the slide housing 38 from crushing the top of the crutch pole 66. A shaft o-ring 128 may be fitted under the top portion of the slide shaft 34 performs a similar protective function.

FIG. 2b shows an embodiment of those elements common to all damping assemblies, using the same hydraulic damper 48 from FIG. 2a. In this figure it is easier to grasp how certain elements interlock to prevent unwanted rotation by means of the sectional views, and are shown by horizontal lines through each area sectioned. The only element added to FIG. 2b is a representative c-clamp 58 with its clamp bolt 60, whereas all other elements are the same as iterated in FIG. 2a above.

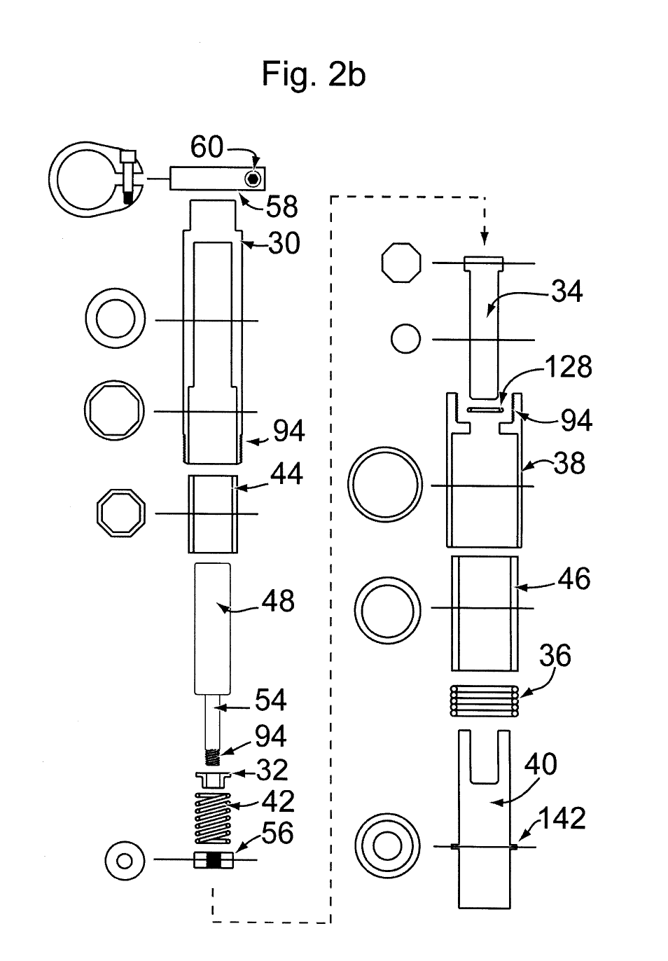

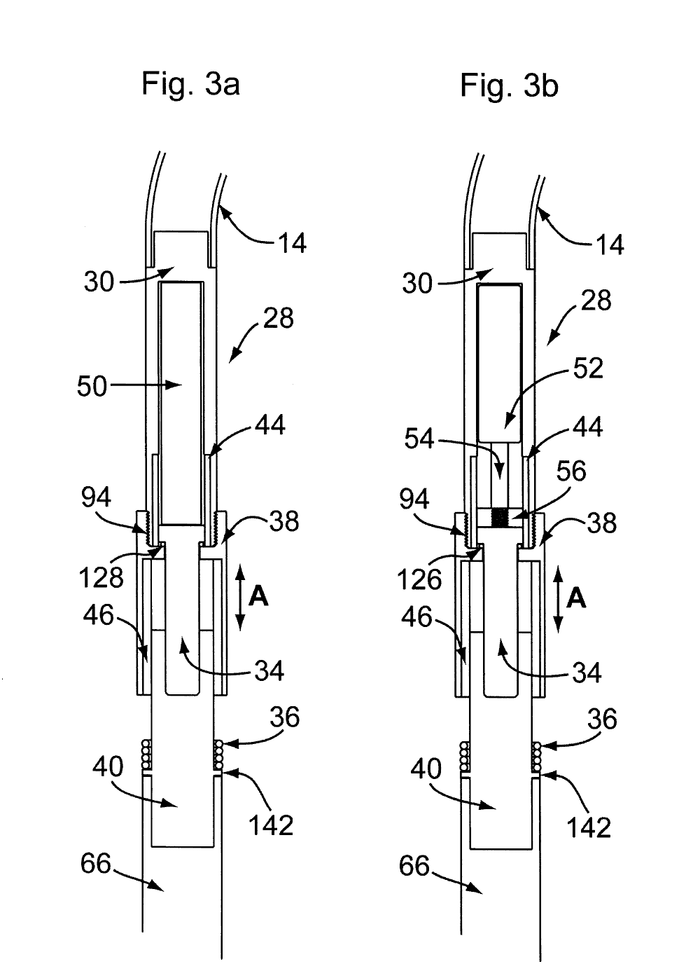

FIG. 3a shows an embodiment of an alternate damping assembly 28 employing an elastomeric damper 50, said element replacing the hydraulic damper 48, piston rod 54, piston plate 56, spring retainer 32 and spring 42 as shown in FIG. 2a. FIG. 3b shows another alternate damping assembly 28 employing an internal spring hydraulic damper 52, which may thereby eliminates the need for a spring retainer 32 and spring 42 as shown in FIG. 2a.

FIGS. 4a and 4b show an embodiment of a general use (or walking) tip 132 comprised of a tip sleeve 70 sliding into the bottom end of the crutch pole 66, which inserts into the tip body 74, and terminates in a removable end cap 68. In order to prevent the bottom end of the crutch pole 66 from crushing the soft rubber of the tip body 74, a wider ring-like tube stop 72 may be slid onto the bottom section of the tip sleeve 70. This tube stop 72 may be press fitted, glued, set screwed or use other means of affixing it to the appropriate location. An alternate solution may be to machine the tube stop 72 as part of the tip sleeve 70, thereby providing a fixed stop instead of a sliding stop. Affixed to the end of the tip body 74 may be an additional layer of cushion 76 and a final layer of traction material known as a sole 78. In addition, an annular indent 138 may be formed or cut into the circumference of the tip body 74 as shown.

FIGS. 5a and 5b show an embodiment of a hiking tip 134 comprised of the same elements as FIG. 4a, except for pointed caulks 82 which may be inserted through holes in the sole 78 and threaded 94 into an aluminum plate 80 affixed to the cushion 76.

FIGS. 6a and 6b show an embodiment of an ice tip 84 comprised of a tip sleeve 70 with a tip body 74, the distal end of which houses an ice pin 90, which may be secured by set screws 92 fitted into indents in the circumference of the ice pin 90. Since the ice tip 84 may be used as one part of the snow tip 136 (see FIGS. 9a to c), the decking plate 88 with rivet holes 86 is used as a tube stop 72 in both tip designs.

FIGS. 7a and 7b show an embodiment of an articulating multi-terrain (AMT) tip 98 employing a sole 78 wherein each pad 110 holds a protruding stud 112. A socket body 108 may attach to the cushion 76 below, form the socket for a ball joint 102 above, and be secured by a ball collar 104 by means of threads 94. The AMT sleeve 100 includes an integral tube stop 72 (as outlined above), and may fastened to the ball joint 102 by means of a ball sleeve bolt 106. An AMT o-ring 130 may both cushions and prevents the bottom edge of the tube stop 72 from damaging the sleeve orifice 140 in the top of the ball collar 104, as the AMT tip 98 is canted at different angles as it strikes non-perpendicular surfaces. Note: In FIGS. 8a, 8c, 8e, and 8g to follow, the AMT tip 98 is the same as in FIG. 7a, and only the foot is configurations change. Note: for purposes of this discussion, the foot portion of a crutch tip are those features intended to contact the ground on a regular basis.

FIGS. 8a and 8b show an embodiment of an AMT tip 98 employing a general use or walking foot, which may be comprised of a cushion 76 and a sole 78 as shown. FIGS. 8c and 8d show an embodiment of an AMT tip 98 with a cushion 76 and employing a sole 78 with exposed studs 112. FIGS. 8e and 8f show an embodiment of an AMT tip 98 with a cushion 76 and employing a sole 78 with recessed studs 112, fitting into stud holes 114. FIGS. 8g and 8h show an embodiment of an AMT tip 98 with a cushion 76 and employing a sole 78 with recessed studs 112, fitting into stud holes 114, where the studs are affixed to a metal plate 116 as shown.

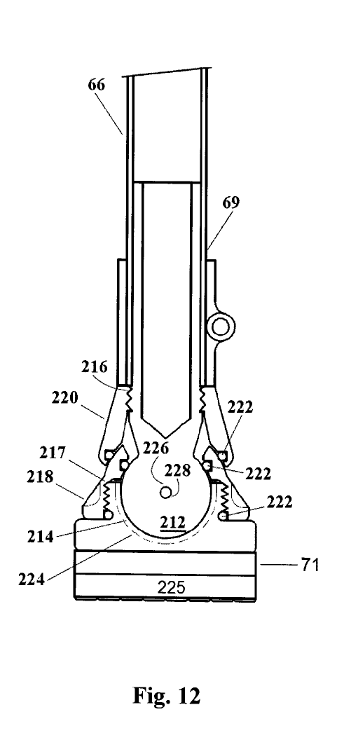

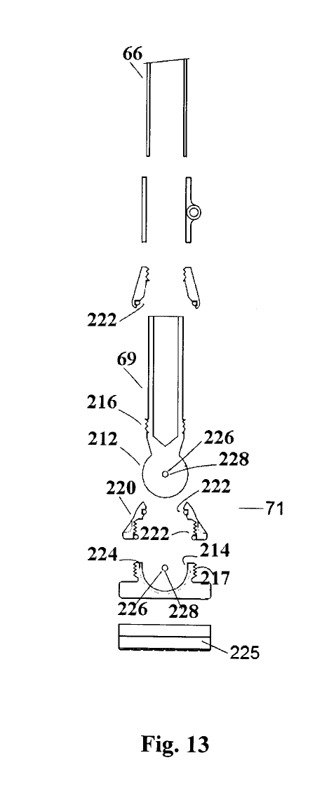

Note: for easier understanding of the following description, refer to FIGS. 12 and 13 together. FIGS. 12 and 13 detail a further embodiment of the connection between the lower end of the crutch pole 69 and a walking tip 71. The lower end of the crutch pole 69 may terminate in a ball 212. The tip 71 includes a tip socket 214 that is complementary with the ball 212, the tip socket 214 and the ball 212 being adapted to connect a walking surface 225 for constrained motion about the lower end of the crutch pole 69.

The lower end of the crutch pole 69 may be further characterized by an externally threaded shaft portion 216 adjacent the ball 212. Similarly, the tip socket 214 may be further characterized by an externally threaded socket portion 217 circumscribing the tip socket 214.

A socket nut 218 and a shaft nut 220 may be slidably mounted coaxially on the crutch pole 66, the socket nut 218 having an internal thread that may be complementary with the externally threaded socket portion 217, and the shaft nut 220 having an internal thread that may be complementary with the externally threaded shaft portion 216. The socket nut 218 may be adapted to draw and retain the ball 212 into the tip socket 214 while allowing constrained motion of the walking surface 225 about the lower end 69 of the crutch pole 66. The shaft nut 220 may be adapted to mate with the socket nut 218, providing reinforcement and further adjustability of the constrained motion.

To improve wear and/or operation, the socket nut 218 and the shaft nut 220 may include environmental seals 222 and the tip socket 214 can include a wax-impregnated leather bearing surface 224 or an alternative surface having low friction known to persons of skill in the art.

Those skilled in the art will recognize that both relative movement between the crutch pole 66 and the walking surface 225 and constraint can be desirable depending on the desired application. For example, for applications like snow shoeing or walking on sand, it could be desirable that the appropriate walking surface 225 articulate but not rotate with respect to the crutch pole 66. For this reason, the ball 212 and the tip socket 214 may include further constraint mechanisms 226, for example a receptacle 228 for receiving a locking pin (not shown).

FIG. 9a shows an embodiment of a snow tip 136 which employs the ice tip 84 and which may be attached to the flexible decking 120 with rivets 126 by means of its decking plate 88 (through rivet holes 86 shown in FIGS. 6a & 6b). The decking 120 material, which may be made from a material such as urethane coated nylon mesh, may be attached by means of rivets 126 to connectors 122 which slot through the serrated frame 118 (see FIGS. 9b & 9c). The flexible decking 120 may further be made from any strong, flexible material known to persons of skill in the art, such as a Kevlar® mesh. The serrated frame 118 may have a diameter of approximately 8″ though a larger or smaller diameter serrated frame 118 may be utilized. FIG. 9b shows the snow tip 136 with the tip sleeve 70 portion of the ice tip 84 sliding into the bottom of the crutch pole 66. The form of the serrated frame 118 can now be seen, and the slots 124 through the frame 118 that hold the connectors 122 are demonstrated. FIG. 9c shows the snow tip 136 with external views of the ice tip 84, serrated frame 118, set screws 92, and ice pin 90. Further, a rubber sole (not shown) may be fitted beneath decking plate 88 to protect the snow tip 136 assembly.

FIGS. 9d to 9f show a further embodiment of a snow tip 240. The snow tip 240 may have a flexible decking 242 tensioned around a frame 244 by connectors 246 having rivets 248. The frame 244 may have a lower serrated edge. The flexible decking 242 may be connected to a central tip 249 capable of sliding into the lower end 69 of the crutch pole 66. The central tip 249 may be threaded to allow for a nut 250 to be screwed on to connect the flexible decking 242 to the central tip 249. A spacer 252 may be placed between the nut 250 and the lower end 69 of the crutch pole 66 to adjust the length of the crutch pole 66 for use with the snow tip 240. An ice pin 254 may be attached to the snow shoe. There may exist and orifice within the central tip 249 suitable for mounting of an ice pin 254. The ice pin may be made of hardened steel or another suitably durable material. There may exists indents in the ice pin 254 used to mount the ice pin 254 to the central tip 249 by means of set screws 256. Further, a rubber sole 258 may be fitted beneath the flexible decking 242 to protect the snow tip 240 assembly. A c-clamp 58 may be used to fix the snow tip 240 assembly to the crutch pole 66.

Further, a sand tip adapted for travel over sandy surfaces such as beach or desert may have a design similar to the snow tip 136 or snow tip 240 of FIGS. 9a to 9c and FIGS. 9d to 9f respectively. The serrated frame 118 and the frame 240 may have a diameter of approximately 4″ for the sand tip.

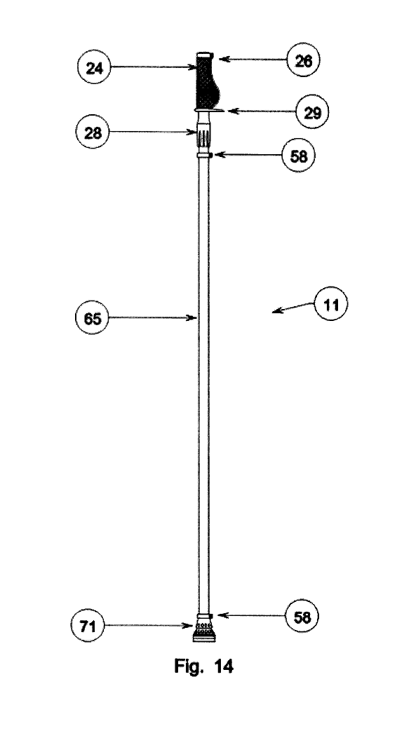

FIG. 14 shows another assistive mobility device according to certain aspects of the invention, namely one embodiment of a representative ergonomic walking stick system 11. The walking stick system 11 may be comprised of an ergonomic hand grip 24 with a hand support shelf 29, a damping assembly 28, and a general use tip 71 at the distal end. The ergonomic hand grip 24 and a hand support shelf 29 may be connected to the damping assembly 28 and may then be connected to a walking stick pole 65 and finally the general use tip 71. The hand support shelf 29 may be cushioned to provide additional support to the user and provide the user with surface for weight bearing. Walking stick pole 65 may be made of a strong material such as a tube of aluminum such that, in conjunction with the hand support shelf, the walking stick system 11 may be capable of supporting up to 100% of a user's body weight. The tip 71 is interchangeable with other tips as described herein. The height of the walking stick system 11 may be adjustable. All tubular elements may be connected by means of c-clamps 58.

One particular embodiment of the multi-terrain damping ergonomic forearm crutch system 10 will now be described in detail to more fully convey specific aspects of the present invention. The integrated elements that make up the novel crutch system have been organized into the following sections describing the attributes and functionality of: the ergonomic forearm assembly 12, ergonomic hand grip 24, damping systems, tip designs, and miscellaneous support elements. Note that by focusing on individual elements or assemblies for purposes of explanation, one does not lessen their functional interdependence in practice.

### Ergonomic Forearm Assembly Design:

FIG. 1b shows the ergonomic forearm assembly 12 which may be comprised of bent forearm tube 14 and an angled handle tube 16 welded to that bend. The angular configuration of the forearm assembly 12 is defined by the reference mark beside the drawing. The angle of the forearm tube 14 and the handle tube 16 may enable the ergonomic positioning for wrist and hand during highly repetitive and weight bearing nature of crutch walking.

One of the present inventors is a Registered Occupational Therapist, and in her professional experience, the optimal biomechanical angle for a crutch forearm assembly 12 is one which allows a more open wrist position angle, for example 100 degrees instead of the almost universally employed 90 degrees. This angle may reduce wrist hyper-extension and permit greater weight bearing on the ulna side (strength side) of the hand. This position may also relieve stress and reduce uneven loads on the surrounding arm and shoulder muscles, as well as related connective tissues and structures. The ergonomic forearm assembly 12 supports both lower and upper arm in a more natural and therefore a stronger biomechanical position. The more ergonomic the position of the biceps and shoulder joint, the more relaxed and responsive is the posture while moving with the ergonomic forearm crutch system 10. This configuration results in reduced fatigue or risk of chronic pain or injury during endurance or extreme outdoor activities such as hiking, mountain climbing, ice travel, skiing, sand walking etc.

An additional functional attribute of the ergonomic forearm assembly 12 is that it may be constructed of tubular dimensions that allow it to interface with common mountain bike handle components such as a multiplicity of ergonomic handles designed to prevent similar ulnar and forearm repetitive injuries. By this means, the present design permits more selection of, and less expensive alternatives for, replacement handles to be found and used, irrespective of the user's location. It should be noted however that bike handle components are not ideally suited to usage within the ergonomic forearm assembly 12 as the hand grip 24 since the wear and stress a bicyclist puts on bike handle components are dissimilar to that users of the ergonomic forearm crutch system 10 exert on the ergonomic forearm assembly 12. A specifically designed hand grip 24 may offer superior comfort to users of the ergonomic forearm crutch system 10.

### Ergonomic Hand Grip Design:

The ergonomic grip is designed for a sports crutch in which users are mostly likely going to go on long walks, hikes, climbs, etc. It can however be extremely beneficial for any user on forearm crutches.

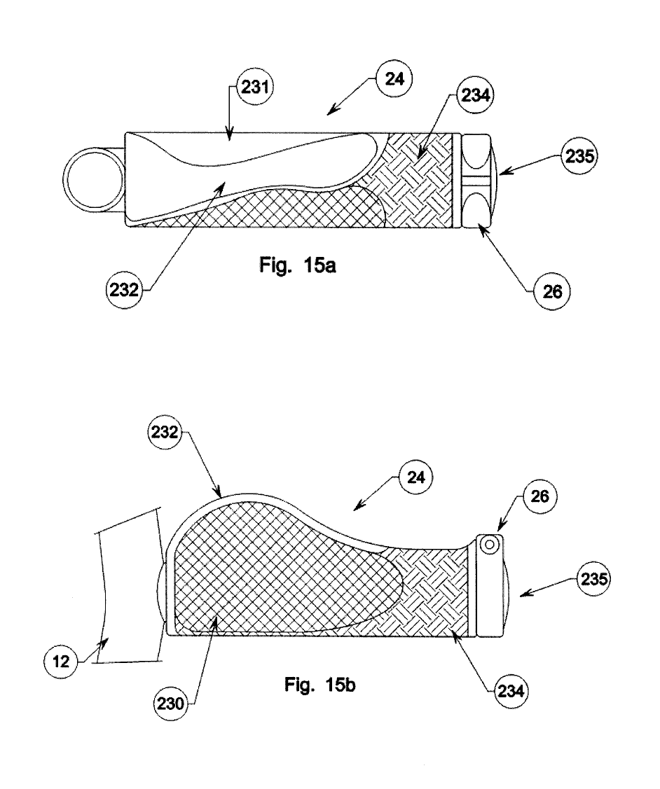

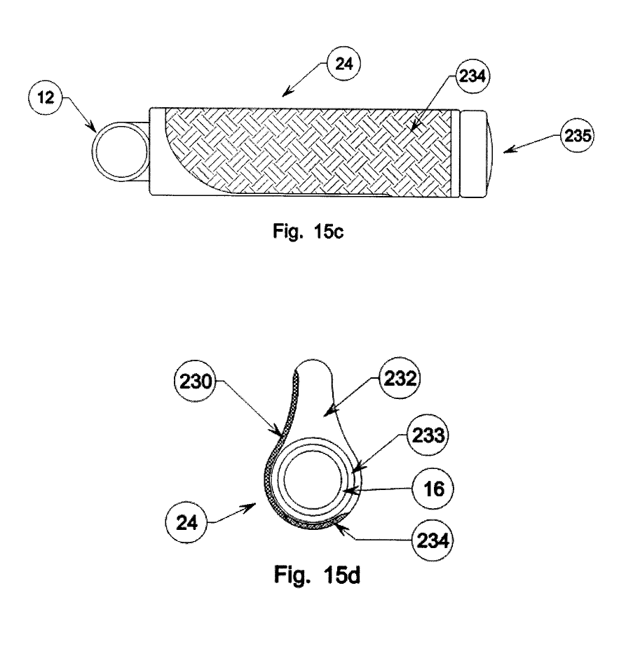

Note: for easier understanding of the following description, refer to FIGS. 15a to 15d together. FIG. 15a, FIG. 15b, FIG. 15c and FIG. 15d detail an embodiment of the hand grip 24. The hand grip 24 may have a tubular body 231 with a supporting portion 232 and an inner sleeve 233, and may be formed by a variety of plastics and elastomeric materials of various durometers (or hardnesses) and arranged to anatomically support the hand when used to bear the weight of a user of an assistive mobility device user. The hand grip 24 may include an end cap 235. The supporting portion 232 may be formed in an ergonomic shape to provide support to the thenar eminence during the heel strike of a user's hand and then support for the rest of the hand during the walking stride to minimize the impact of walking with an assistive mobility device and to provide stability to the user.

The inner sleeve 233 may be tubular and run the length of the is hand grip 24 within the tubular body 231. The hand grip 24 may be attached to the crutch system 10 at, for instance, the ergonomic forearm assembly 12 or walking stick system 11 by using a c-clamp and respective grip bolt 26 to fix the sleeve 233 to the handle tube 16 of the ergonomic forearm assembly 12. The grip bolt 26 allows the user to alternate the position of the hand grip 24 with supporting portion 232 to increase comfort, as well as allow user to alter weight bearing areas during extended walking periods.

The ergonomic hand grip 24 and associated c-clamp and respective grip bolt 26 may allow for positioning the hand and wrist of the user in an optimal ergonomic alignment, such as to align the third metacarpal bone with radius bone of the arm for grip. The angle of wrist may be aligned to 15 degree of extension. Altering of the grip angle adjustments on the hand grip 24 to change weight bearing surface areas of hand may be done for temporally relief during extended activity/walking.

An elastomeric weight bearing surfaces 230 along a portion of the supporting portion 232 may be substantially flat with a slight convex design to form a rolling surface. The supporting portion 232 may be formed in an ergonomic shape to provide support to the thenar eminence during the heel strike of a user's hand and then support for the rest of the hand during the walking stride to minimize the impact of walking with an assistive mobility device and to provide stability to the user. The elastomeric weight bearing surfaces 230 may be formed in an ergonomic shape to provide support to the thenar eminence, or the heel of the hand, to minimize the impact of walking with an assistive mobility device and to provide stability to the user. The thenar eminence is the location at which the greatest impact is made between the hand and the hand grip 24 when a user is walking with an assistive mobility device.

An elastomeric grip surface 234 may also exist in the hand grip 24 around a portion of the tubular body 231. After the hand makes contact with hand grip 24 at the thenar eminence, the user transfers their weight through their palm to the lower metacarpal region of the hand. The hand may then exert a push-off force onto the hand grip 24 through the lower metacarpal region of the hand to propel the user of the assistive mobility device forward. The grip surface 234 may be placed in the region in which this force is exerted from then hand onto the hand grip 24 during push-off from the hand grip 24.

There may be more than two elastomeric weight bearing surfaces on the hand grip 24 to provide a more comfortable weight bearing surface for users of the hand grip 24. Each elastomeric surface may be customized with different elastomeric materials of varying hardnesses to provide specific weight bearing properties to the user. By padding the regions in which force is transferred between the hand and the hand grip 24 with elastomeric materials of various durometers, impact may be controlled and medical conditions such as carpal tunnel syndrome, tendinitis and neuropathy may be avoided. Such medical conditions are common in users of assistive mobility devices due to the repeated stresses their hands endure while walking.

Elastomeric material may be embedded into hand grip 24 at the elastomeric weight bearing surface 230 and the elastomeric grip surface 234 to improve comfort for the user. The elastomeric materials may be distributed over the surface of the hand grip 24 such that 100% of weight borne by the hand grip 24 is absorbed by the elastomeric weight bearing surface 230 and the elastomeric grip surface 234. Up to 100% of the user's weight may be borne by the hand grip's 24 elastomeric weight bearing surface 230 and the elastomeric grip surface 234. It should be noted that bike handle grips are not designed to bear 100% of a user's body weight. Should a bicycle user bear this much weight onto their hand grips in a repeated manner such as how a user of an assistive mobility device stresses the hand grip 24, excessive wear would be seen on the bike grip.

The hand grip 24 may be made from a hard material such as a rigid plastic which, while strong and able to hold its shape, does not provide an assistive mobility device user with much comfort should they apply their weight directly to the material. The hand grip 24 may provide an ergonomic shaped handle having elastomeric inserts of various densities on the grip surface area that complement the hand during usage of an assistive mobility device, such as a crutch or walking stick.

The elastomeric materials may increase the contact between weight bearing surfaces of the hand and the anatomical hand grip 24 while reducing the compression (e.g.: lower the impact of stress) on highly sensitive areas of the inner hand. For example, the heel of one's hand while using an assistive mobility device acts like the heel of foot taking the initial impact force of one's foot striking the floor during walking. The thenar eminence (the large muscle portion at base of thumb) and the entire thumb if wrapped around the supporting portion 232 add stability. The base of the metacarpal bones provide for the ability of weight transfer from the heel of the hand to the fore-hand for push off of an assistive mobility device, similar to the push off of the ball of the foot in able-bodied individuals. These weight bearing areas may be supported by varied elastomeric surface densities similar to the support provided by the elastomeric properties (e.g.: cushions to absorb impact) of a running shoe. As force is transferred from the thenar eminence to the assistive mobility device, the elastomeric materials deform to better absorb force as it is transferred from the user to the walking device.

### Damping Systems:

Damping is the capacity built into a mechanical device to prevent excessive correction, which results in instability or oscillatory conditions. Damping is any effect, either deliberately engendered or inherent to a system that tends to reduce that system's amplitude of oscillations. Unlike a spring, or a common shock absorber, a damper absorbs weight to a certain point, and then slowly releases the weight back to the starting point in a controlled fashion. The kind of hydraulic damper 48 used with the ergonomic forearm crutch system 10 and the walking stick system 11 may be an extension damper which is adjustable in the return force supporting the weight of the user. The user can manually adjust the amount of return force provided by the damper by turning the piston 54 a number of turns in a specified direction, as per the manufacturer's instructions. Therefore any damping assembly 28 employing a hydraulic damper 48 can be adjusted to support users of different weights, thereby providing the optimal stroke motion and return duration for maximum comfort and safety. An embodiment of the ergonomic forearm crutch system 10 employs a hydraulic damper 48 as the core element of the damping assembly 28 which will now be described in detail.

### Hydraulic Damper Assembly:

As shown in FIGS. 2a & 2b, the damping assembly 28 employing a hydraulic damper 48 may be a tubular mechanism that absorbs the weight of a user as they move with the crutch. Hydraulic dampers 48 may be cylindrical cartridges filled with a compressible gas such as nitrogen, such that when weight is placed on the piston 54, it retracts into the cartridge at a given rate. Such a damper may be referred to as a gas damper. Hydraulic dampers 48 may also employ oil seal chambers, which when vented between chambers, control or moderate the rate of piston travel. Damping assemblies 28 may also employ elastomeric dampers 50 in place of the hydraulic damper 48, or may employ a hydraulic damper with an internal spring 52, but these alternate embodiments will be described further in the appropriate section below.

As shown in FIGS. 2a & 2b, the damping assembly 28 slides partway into the bottom of the ergonomic forearm assembly 12 and partway into the top of the crutch pole 66, and may be both fastened by means of c-clamps 58 at the top housing 30 and coupling 40 respectively. In both cases there may be a means to prevent damage to components if the c-clamps 58 are loosened for any reason, namely the forearm tube 14 may be stopped by the ledge at the top of the top housing 30, and the top of the crutch pole 66 may be stopped by the slide flange 142 of the coupling 40. The hydraulic damper 48 may be held inside the top housing 30 so that the piston plate 56 threaded 94 to the piston 54 may be pressing on the top of the slide shaft 34. In this embodiment, a compression spring 42 and spring retainer 32 may be fitted over the piston 54, behind the piston plate 56, so that when weight is applied to the hydraulic damper 48, the spring 42 provides an increasing force to absorb the weight of the user, easing them down gently. When the user's weight is removed however, the hydraulic damper 48 may prevent the spring 42 from returning to its maximum extension too rapidly, and thereby prevents the “pogo stick” action common in prior art solutions. Springs 42 of the same length may be selected for different compression ranges (tension) by using a is denser or thicker-wire size. Spring 42 tensions may be selected according to weight of user so as to provide a safe margin of support.

While the damper 48 and spring 42 provide optimal suspension for crutch walking, they also may require a means to ensure both smooth and reliable operation during many repetitions, as well as a means to prevent unwanted horizontal rotation of components during use. The sliding elements of the damping assembly 28 may be the solution to both these requirements. The sliding elements start from the internally hexagonal lower section of the top housing 30, wherein is fitted a hexagonal plastic guide 44, into which slots the hexagonal top portion of the slide shaft 34, and which is normally in contact with the piston plate 56. By this means, the slide shaft 34 is prevented from horizontal rotation, and when its bottom portion, which slides through the top of the slide housing 38, is secured into the top of the coupling 40, and that is secured to the crutch pole 66 by a c-clamp 58, the entire upper section of the crutch is now prevented from any unwanted horizontal rotation or yawing. Vertical movement of the damping assembly 28 may be need, and should be as frictionless as possible, therefore a cylindrical Teflon® guide 46 may be inserted between the coupling 40 and the inside wall of the slide housing 38.

Elastomeric o-rings may allow for adjustment of travel range, may provide a gentle final stop, and also act as a crash barrier if suspension components fail. The number of coupling o-rings 36 stacked onto the coupling 40 depends on the required stroke length (see A in FIGS. 2a, 3a & 3b), which usually varies depending on the weight of the user. The shaft o-ring 128 at base of top housing 30 is used to decrease noise during the return stroke.

### Tip Designs:

All tips designs employ tip sleeves 70 and 100 which slide into the lower end of the crutch pole 69 and may be secured by tightening the clamp bolt 60 of the c-clamp 58. All tips also normally require a means to arrest the crutch pole 66 at a specific point on the tip sleeve 70, in case the c-clamp 58 should fail. In most tips, this may be done by means of the tube stop 72, and in the case of the ice 84 and snow tips 136, by their decking plate 88, which acts as a tube stop 72. Tube stops 72 are either a cylindrical ring which slides on the tip sleeve 70 or a widened diameter of the tip sleeve 70 just above the softer tip body 74. Whether they are used depends on the structural resilience of the tip body 74 material. If the tip body 74 can support the combined body weight of the user and the force of impact while moving with the crutch, then a tube stop 72 may not be necessary. The tube stop 72 distributes the forces from the bottom of the crutch pole 66 over a wider surface area of the top of the tip body 74. The object is to prevent the crutch pole 66 from crushing through the tip body 74, thereby damaging the tip, and potentially becoming a safety hazard to the user.

For purposes of this disclosure, interchangeable tips are classified as static, articulating multi-terrain (AMT), or extreme (ice & snow). Specific sub-classifications define how each tip works best in its primary environment, but these classifications are broadly descriptive, and not limiting if other functionalities are discovered.

### Static Tips:

Two static tips are illustrated, namely the General Use (Walking) Tip 132, and the Hiking Tip 134. Both static tips have a similar tip body 74 design, and employ a soft rubber cushion 76 that both absorbs impact, and allows the sole 78 additional flexibility to maintain maximum contact with the ground. Both static tips have an annular indent 138 around the mid-section of the tip body 74 just above the soft rubber cushion 76 that increases flexion of the tip up to a 30 degree angle, and thereby allows the sole 78 of the tip to remain on the floor longer during the swing phase of crutch walking. As shown in FIGS. 4a & 4b, the sole 78 of the general use (walking) tip 132 is made of Vibram® rubber or similar material for optimal traction on commonly encountered surfaces in urban or rural streets such as asphalt, concrete, or cobblestones. As shown in FIGS. 5a & 5b, the sole 78 of the hiking tip 134 employs additional screw-in caulks 82 threaded 94 into an aluminum plate 80 which is bonded between the soft rubber cushion 76 and the Vibram® rubber sole 78. The caulks 82 may provide additional traction on hiking trails, undeveloped roadways, wooden bridges, or any surface where a rubber sole 78 might lose traction due to softer, slippery or uneven terrain.

The annular indent 138 around both the general 132 and hiking tip 134 bodies may be used to increase the flexibility of the bottom portion of these tips, and to allow the foot of the tip to remain in contact with the ground longer than with more rigid tip body designs. When a tip does not have sufficient surface area in contact with the ground, it cannot provide sufficient traction. Without a means to allow the tip to flex with any contacting surface, the tip is likely to skid along the ground on its edge, which is unsafe for the user, and damaging to the tip. The static tips solve this problem by means of the annular indent 138, whereas the articulating tips 98 solve it with their ball joint 102 and socket body 108 assemblies. As evident from FIG. 4a or 5a, if the bottom portion of these tips hits an inclined surface, the closest sector of the annular indent 138 will allow that area of the tip body 74 to compress, and thereby allow the sole 78 to maintain optimal contact with the ground. Therefore an object of the annular indent 138 on these tip bodies 74 is to allow sole 78 to maintain connection with the surface of the ground even when it is angled to the direction of impact of the crutch tip.

### Articulating Multi-Terrain (AMT) Tips:

As shown in FIGS. 7a to 8h, all AMT tips 98 employ the same body design, but employ one of five different sole 78 designs, namely general use (walking), protruding studs, exposed studs, recessed studs, or recessed studs with metal plate. FIG. 7a shows a close-up of the AMT tip 98 body design where the ball joint 102, a low friction plastic sphere, is fastened to the bottom of the AMT tip sleeve 100, and rides in a correspondingly spherical socket embedded in the socket body 108. The ball collar 104 compresses the ball joint 102 against the socket body 108, by means of threading 94 on both parts, and this determines how freely the ball joint 102 is able to move within the socket body 108. The resultant rotational freedom of the crutch tip from the crutch body allows the user's shoulder to slightly rotate externally, while swinging through each stride. This has the potential to reduce user fatigue, by allowing a more natural positioning of the shoulder in relation to the body—during the swing portion of the stride.

A primary object of any AMT tip 98 is its ability to change its angle when contacting unevenly angled terrain so that the sole 78 of the tip presents the largest surface area at every contact with the ground, and thereby provides optimal traction for the user. The AMT tip 98 allows each foot a nominal 60 degree range of articulation around the axis of the AMT tip sleeve 100. In order to permit this range of articulation, the sleeve orifice 140 in the top of the ball collar 104 is widened and beveled as shown in FIG. 7a. To prevent the metal AMT tip sleeve 100 from damaging the sleeve orifice 140 of the plastic ball collar 104 as it articulates, a cushioning AMT o-ring 130 is inserted as shown. The AMT o-ring 130 can vary in size to increase or decrease the range of foot articulation, and also acts as a seal to prevent water, contaminants, or abrasive materials from entering and possibly damaging the inside of the socket body 108 assembly.

Other objects of the AMT tip 98 include soles 78 designed to provide traction on multiple terrains, and which provide nominally wider surface areas contacting the ground than soles 78 found on static tip designs. AMT tips 98 use metal studs 112 instead of caulks 82 of the hiking tip 134, and perform a similar function in that they provide optimal traction on slippery or uneven terrain by biting into the surface of the ground. Studs 112 in the preferred embodiment are hexagonal flat headed stainless machine screws which are driven into and secured in the sole 78 material. The general use (walking) foot employed with the AMT tip 98 does not use studs 112, but employs a Vibram® sole 78 as shown in FIGS. 8a & 8b. Four studded sole designs are available: with studs 112 affixed to protruding pads 110 (FIGS. 7a & 7b); studs 112 affixed flush to the sole 78 material (FIGS. 8c & 8d); studs 112 affixed into stud holes 114 in the sole 78 material, thereby providing the potential to use this foot indoors without damaging flooring because the studs 112 are level with the sole 78 (FIGS. 8e & 8f); and studs 112 affixed into stud holes 114 in the sole 78 material, through a reinforcing metal plate (FIGS. 8g & 8h). Note that studs 112 may also be embedded into the sole 78 material as part of its forming process, but this may preclude the option to replace damaged studs 112. Studs 112 embedded in stud holes 114 decrease the noise made when walking over harder surfaces such as cobblestones, logging roads, hardwood floors. The embedding depth of threaded machine screws or anchoring pins securing the studs 112 to the sole 78 material or beyond, are optimally greater than the height of the studs 112 projecting beyond the anchoring surface.

### Extreme Tips:

Two extreme tips are available, namely the ice tip 84 (FIGS. 6a & 6b), and the snow tip 136 (FIGS. 9a to 9c), with the latter being assembled around the former.

The ice tip 84 allows the user to crutch walk on glaciers, ice fields, or even urban streets covered with frozen water. It is primarily comprised of cylindrical tip sleeve 70 and tip body 74 sections (see FIG. 6a), the latter housing a replaceable ice pin 90 in the end contacting the ground. Since the ice tip 84 can be used to assemble a snow tip 136, and since it needs some form of tube stop 72, for the reasons outlined above, the decking plate 88 is retained in both tips and serves this purpose. The decking plate 88 may be welded in place or may be affixed by other means approximately halfway down the ice tip 84, and retains the rivet holes 86 to be used for the snow tip 136. The ice pin 90 may be fixed in place by means of at least two set screws 92, the ends of which are screwed into corresponding indents 96 in the ice pin 90 body. By this means, the ice pin 90 may be firmly secured in the end of the ice tip 84, and by loosening the set screws 92, one may replace the ice pin 90 if blunted or bent during extreme use.

The snow tip 136 shown in FIGS. 9a to 9c is used as a crutch walking snow shoe and may be used as an expedient sand shoe. As mentioned above, the snow tip 136 is assembled around the ice tip 84 by affixing a flexible, strong, weatherproof decking 120 material to the decking plate 88 by means of rivets 126 through existing rivet holes 86 (see FIGS. 6a & 6b). The decking 120 is then attached with rivets 126 at equidistant points around its circumference to rigid connectors 122 fitting through slots 124 in the circular serrated frame 118. The object of the decking 120 is to create a sufficiently large contact area to distribute and support the weight of the user as they crutch walk on the surface of the snow (or sand). The object of the serrated edge of the frame 118 is to enable the user to punch through snow with an icy crust which otherwise may prevent sufficient frame 118 insertion into a variable density surface. The object of retaining an ice tip 84 as part of the snow tip 136 assembly is the necessity to punch through an icy crust, only to encounter a deeper unyielding ice or ground layer. In this circumstance, without the tip body 74 section of the ice tip 84, the frame 118 of the snow tip 136 would likely not have enough stability to maintain traction or support.

### Support Elements:

The following section details various support elements that may be necessary to full operation of the ergonomic forearm crutch system, namely the cuff 18, hand grip 24, crutch pole 66, and modular component clamping solutions.

As shown in FIGS. 1a & 1b, the cuff 18 slides into the top of the forearm tube 14 by means of its pivot arm 22. The pivot arm 22 allows the ring of the nylon cuff that wraps around, cushions, and cradles the upper arm, to pivot around its pivot bolt 20. By this means, the user may adjust their upper arm to varying loads, terrains and inclines. The diameter of the forearm tube 14 is designed to accept, available cuffs with similar diameter insertion means or cuffs 18 which may be specifically retrofitted to fit the novel crutch system 10.

The top back area of the arm ring portion of the cuff 18 may also be used to house the (Allen) bolt key 62 in its key slot 64. By this means the bolt key 62 used to adjust and tighten the four c-clamps 58 is readily accessible for use, and is readily stowable so that such a tool for the safe operation of the crutch system 10 is available when needed to help one navigate variable terrain. A groove may be incorporated in the body of the cuff 18 to receive the angled portion of the bolt key 62 so that it is flush with the top surface of the cuff 18 in order to prevent the end of the bolt key 62 from being inadvertently pulled from its key slot 64 and potentially lost.

The hand grip 24 that slides onto the handle tube 16 can be any ergonomic or regular bike handle that fits commonly used ⅞ inch diameter tubing. This allows the user to employ the custom hand grip 24 they prefer from a multiplicity of readily available handles designed for cycles or crutches. Also, the user can readily replace a damaged handle in the field, or in another country, by employing readily available cycle hand grips. The ergonomic hand grip 24 shown in FIGS. 1a & 1b is designed to completely and comfortably fill the space in a user's palm with the enlarged hand grip 24 so that full control of the handle tube 16, and therefore of the crutch system 10, is easily possible. The hand grip 24 is secured to the handle tube 16 by means of a c-clamp and respective grip bolt 26, which prevents unwanted and potentially unsafe rotation of the grip 24 around the handle tube 16.

The crutch pole 66 may be made from aircraft aluminum hollow tubing, its top sliding onto the end of the damping assembly 28, and bottom over the tip sleeve 70, and its securement position in the latter case can be partly extended up the tip sleeve 70 by varying where one fastens the c-clamp 58.

Clamping of modular components is achieved by means of c-clamps 58 which, when tightened by their clamp bolts 60 with the bolt key 62, compress the tubing (crutch pole 66 or forearm tube 14) around each component. Reliable securement is only made possible when the component to tube distance (tolerance) is small enough (see FIG. 2a: forearm tube 14 to top housing 30) so that c-clamp 58 compression of the tubing completely around (see FIG. 2b: sectional view of c-clamp 58) each component clamping area is effective. In the present embodiment, all bolts used to fasten c-clamps 58 or other elements employ Allen key heads, so that only one bolt key 62 is required to maintain the crutch system 10. The bolt key 62 is sized to be compatible with common cycling components, so that if one loses their key, they may be able to borrow the compatible Allen key to adjust and or secure their crutch system 10.

Other embodiments of the ergonomic forearm crutch system 10 will now be described in detail. Further similar embodiments and similar methods leading to the same result will occur to those skilled in the art and are considered to be in accordance with the spirit and general teachings of the present systems.

As shown in FIG. 3a the hydraulic damper 48 employed in the illustrated embodiment may be replaced with an expedient elastomeric damper 50, such as those commonly used in front fork suspensions for mountain bikes. This allows the crutch walker traveling in less developed countries to secure a readily available substitute for an inoperable hydraulic damper 48, allowing her to continue her journey until she can find the proper replacement part. The elastomeric damper 50 may also be used as a less expensive alternative to the preferred embodiment.

As shown in FIG. 3b, another alternate embodiment employs an internal spring hydraulic damper 52 which acts in the same manner as the hydraulic damper 48, but with a spring or an equivalent functional mechanism inside the damper cartridge. For this reason, an external spring 42 and its retainer 32 are not needed in this embodiment.

The c-clamp 58 may also include a version with low profile quick release lever instead of an alien head bolt as a securement means. However, the advantage of the latter is more reliable clamping, whereas a quick release may become disengaged inadvertently if the lever is caught on something. The advantage of the quick release is convenience when changing components, so that if there were a means to prevent unlocking during travel, this method may be employed in place of some or all c-clamps.

Crutch poles 66 made of carbon fiber (see below) allow one to manufacture a floating marine crutch system 10, with all components made from synthetic waterproof high-strength plastics, tubing filled with foam for floatation if needed, use of the lighter weight elastomeric damper 50, or none at all, and with the object that the crutch system 10 could be used in a marine environment, such as from a kayak, and would float on water. Note that variations employing the use of an elastomeric damper or no damper also apply to the use of skiing attachments such as a skiing foot.

The appropriate and alternate materials used to manufacture the Multi-Terrain Damping Ergonomic Forearm Crutch System 10 will now be described, if not mentioned elsewhere in this document.

The caulks 82 or studs 112 used on the soles 78 of static and articulating feet may also be made of appropriate non-metallic materials such as rigid hard rubber, Fastex® style plastics, or any material that would increase traction on a wider variety of base surfaces. The object of using non-metallic caulks 82 or studs 112 as traction elements is to provide both the required outdoor grip, yet allow the user to move across interior flooring without causing damage to said flooring and without being forced to change to a softer tip to prevent such damage.

Tip bodies 74 of both static tips: general use (walking) (FIG. 4a), and hiking (FIG. 5a), are formed with rigid light-weight resilient rubber such as polyurethane, or any material with similar properties. Cushion 76 materials should be light weight, pliant, and resilient and can be made from natural or synthetic rubber, urethane ethylene, propylene, silicone, EVA, or similar materials. Soles 78 may be made from Vibram® TC-1 rubber outsole material, as well as 5.10 Stealth® soles or any similar outdoor tread material that can endure the chosen terrain. Vibram is an elastomeric material (vulcanized natural and or synthetic rubber) with a hardness of 30-80 Shore A (Durometer), and reduces the physical impact on joints and the noise of contact with hard surfaces. Vibram® soles are more durable, but Stealth® soles are stickier, so the user must select the sole 78 material most appropriate to their chosen terrain.

The cuff 18 is made primarily from a 606 nylon/Dupont Zytel® blend of plastics, for strength, durability, and waterproofing. Other cuffs would be chosen by the user, but must fit the diameter of the forearm tube 14, and permit similar ergonomic advantages as the original cuff 18.

Tubing, namely the crutch pole 66 and ergonomic forearm assembly 12, are made from high grade 6061 aluminum, chosen for its strength, durability, and availability (used to make most mountain bike frames now). Tubing may also be made from titanium for its strength & durability, or carbon fiber for its lightness. (see marine version above)

The hydraulic damper 48 employed in this embodiment is an extension damper from Ace Controls, part number HB-15-25-88-M, with a stroke length of 25 mm (which may be reduced to approximately 8 mm with the use of coupling o-rings 36), and is able to support a maximum force of 800 Newtons. The spring 42 employed with the hydraulic damper 48 is made from stainless steel for rust-resistance and responsiveness, i.e. stainless steel responds with less speed and rebound force, preventing the “pogo-stick” effect mentioned above. The spring 42 is from Ammtech, part number 80-604-8000-1500c-ceg-l-ss, and is eight left-hand wound 0.08 inch coils made from T302 stainless steel, with an approximate 62.87 lb/inch rate of deflection (travel), and a recommended load capacity of 30 pounds (US).

The ice pin 90 may be made from tungsten carbide alloy or hardened stainless steel or any material with similar strength & resilience. Decking 120 for the snow tip 136 can be made from PVC or urethane coated material with a minimum density of 45 oz/sq. yd. The serrated frame 118 may be constructed in aluminum or stainless steel, with the former material lighter, but not stronger than stainless. An aluminum frame 118 may be powder coated so that ice does not build up on the snow tip 136 during extended use.

Other advantages of using the ergonomic forearm crutch system 10 over other methods or devices are described herein. The adaptability of a modular crutch system 10 allows one to employ existing cuff designs and mounting methods, off the shelf handlebar grips from most contemporary bicycles, and tubing of the same specifications as that used for bicycle handlebars. The modularity of the system 10 is adaptable to activities such as mountaineering, kayaking, skiing, long distant walking, biking/motorcycle travel (bike model would break down into travel size pieces), etc. Modular components can be disassembled and attached to a kayak, motorcycle, or bicycle during travel, or compactly stored in a suitcase, backpack or briefcase. For this latter functionality, the crutch pole 66 may be constructed as two separate tubes connected together by means of an internal cylindrical rigid sleeve joint which is compressed by means of a c-clamp 58. By this means, the crutch pole 66 may be broken down into two parts approximately equal in length for storage or travel. Multi-terrain tips allow safe travel along gravel (logging roads), asphalt, cambered roads, sand, concrete, mud, water, skiing trail, mountain trail, desert trail, cobblestones, bailey bridges, log bridges, etc. The damping assembly can be also retrofitted to all tubular support devices such as walking sticks, crutches, canes, walkers, ski poles, etc.

The foregoing description of illustrative embodiments of the apparatus and methods of operation and construction should be considered as descriptive only, and not limiting. Other manufacturing techniques, configurations, and materials may be employed towards similar ends. Various changes and modifications will occur to those skilled in the art, without departing from the true scope of the disclosure.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1-37. (canceled)

38. A modular assistive mobility device, the device comprising:
a) a first pole having a distal end and a proximal end, the distal end configured to removably accept a contactor;
b) a forearm assembly removably connected to the first pole at the proximal end, the forearm assembly comprising:
i) a second pole; and
ii) a hand support having an ergonomic hand grip, wherein the hand support is removably connected to the second pole in the vicinity of a distal end of the second pole; and
c) an upper support member removably connected to a proximal end of the second pole.

39. The modular assistive mobility device of claim 38 further comprising a damping mechanism, the damping mechanism located in the vicinity of the hand support.

40. The modular assistive mobility device of claim 39 wherein the damping mechanism is removable.

41. The modular assistive mobility device of claim 39 wherein the damping mechanism is comprised of at least one of:
(a) a hydraulic damper;
(b) a gas damper;
(c) an elastomeric damper; and
(d) an internal spring hydraulic damper.

42. The modular assistive mobility device of claim 39 wherein the hand support is adjustably connected to the second pole.

43. The modular assistive mobility device of claim 39 wherein the upper support member is a cuff.

44. A modular assistive mobility device comprising:
a) a first pole having a distal end and a proximal end;
b) a contactor removably attached to the distal end;
c) a damper removably connected to the proximal end;
d) an optional second pole removably connected to the damper, the optional second pole having an upper support member removably connected to a proximal end of the optional second pole; and
e) a hand support having an ergonomic hand grip, the hand support removably connected to a proximal end of the damper.

45. The modular assistive mobility device of claim 44, wherein the contactor is selected from the group consisting of:
(a) a walking tip;
(b) an exposed stud walking tip;
(c) a recessed stud walking tip;
(d) a hiking tip;
(e) an ice tip;
(f) a snow tip; and
(g) a sand tip.

46. The modular assistive mobility device of claim 45 wherein the contactor is releasably connected to the distal end of the first pole by a ball and socket joint.

47. The modular assistive mobility device of claim 44 comprising the second pole, the second pole having a bend.

48. The modular assistive mobility device of claim 47, wherein the hand support is connected substantially normal to the outside bend of the second pole.

49. The modular assistive mobility device of claim 48, wherein a substantially T-shaped connector is disposed between the damper and the second pole for removably attaching the hand support.

50. The modular assistive mobility device of claim 49, wherein the device is a crutch.

51. The modular assistive mobility device of claim 50, wherein the upper support member is a forearm cuff.

52. The modular assistive mobility device of claim 44, wherein the hand support is connected along a longitudinal axis of the first pole.

53. The modular assistive mobility device of claim 52, wherein the device is a sports pole.

54. A removably end for an assistive mobility device comprising:
(a) a mating member for engagement with a first pole;
(b) a clamp;
(c) a stop; and
(d) a tip, the tip selected from a walking tip, an exposed stud walking tip, a recessed stud walking tip, a hiking tip, an ice tip, a snow tip, and a sand tip.

55. The removable end of claim 54 further comprising a self-leveler.

56. The removable end of claim 55 wherein the self-leveler is an annular indent or a ball and socket joint.

57. A modular assistive mobility device kit, the kit comprising:
i) a first pole having a distal end and a proximal end;
ii) at least one contactor for removable attachment to the distal end of the first pole;
iii) a damper for removably connecting to the proximal end of the first pole;
iv) a second pole;
v) a hand grip;
vi) a substantially T-shaped connector for removably connecting the damper to the second pole and the hand grip; and
vii) an upper support member for removably connecting to a proximal end of the second pole.
